(19) United States
(12) Patent Application Publication
(10) Pub. No.: US 2013/0132906 A1
(43) Pub. Date: May 23, 2013

(54) ICON INTERACTION APPARATUS AND ASSOCIATED METHODS

(71) Applicants: Markus Siurumaa, Oulu (FI); Ari-Pekka Peltola, Jaali (FI)

(72) Inventors: Markus Siurumaa, Oulu (FI); Ari-Pekka Peltola, Jaali (FI)

(73) Assignee: NOKIA CORPORATION, Espoo (FI)

(21) Appl. No.: 13/529,461

(22) Filed: Jun. 21, 2012

Related U.S. Application Data
(60) Provisional application No. 61/632,810, filed on Jun. 29, 2011.

(51) Int. Cl. G06F 3/0481

(52) U.S. Cl. CPC G06F 3/04817
USPC 715/835

(57) ABSTRACT

An apparatus comprising:
at least one processor; and
at least one memory including computer program code,
the at least one memory and the computer program code configured to, with the at least one processor, cause the apparatus to perform at least the following:
detect a particular user interaction, from a plurality of detectable user interactions each of the plurality of detectable user interactions associated with
   a particular application icon on a user interface of an electronic device, and
   one of a plurality of operating modes of the application associated with the particular application icon; and
initiate automatic opening of the particular application in the respective one of the plurality of operating modes associated with the detected particular user interaction.

### CROSS REFERENCE TO RELATED APPLICATION

This application claims priority to and the benefit of U.S. Provisional Application No. 61/632,810, filed on Jun. 29, 2011, which is incorporated by reference herein in its entirety.

### TECHNICAL FIELD

The present disclosure relates to the field of user interfaces configured to enable the user to interact with application icons, associated methods, computer programs and apparatus. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs).

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Electronic devices may enable one or more applications to be opened on a device (e.g. simultaneously). Generally, to open an application the user is required to click on an icon, interact with a menu and/or enter a command (e.g. in a command line interface). Once the application has been opened and is running, the user may interact with the application using a user interface.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect there is provided an apparatus, the apparatus comprising:
at least one processor; and
at least one memory including computer program code,
the at least one memory and the computer program code configured to, with the at least one processor, cause the apparatus to perform at least the following:
detect a particular user interaction, from a plurality of detectable user interactions, each of the plurality of detectable user interactions associated with
   a particular application icon on a user interface of an electronic device, and
   one of a plurality of operating modes of the application associated with the particular application icon; and
initiate automatic opening of the particular application in a respective one of the plurality of operating modes associated with the detected particular user interaction.

It will be appreciated that each application is associated with a plurality of different operating modes and, depending on which user interaction with the corresponding icon is used to open the application, the application will open in a respective operating mode.

An operating mode of an application may define the configuration of an application. That is, operating mode may define the behaviour (e.g. default behaviour) and/or capabilities of the application. The operating mode may dictate what information is supplied to the user and/or the functions available to the user. For example, a said operating mode may be a background operating mode (e.g. running but not immediately visible/accessible to the user and/or indirectly visible/accessible to the user), a foreground operating mode (e.g. directly visible/accessible to the user), a safe operating mode (e.g. where certain functions/capabilities of the application are restricted), an edit operating mode (e.g. wherein data is presented in an editable format), a sleep operating mode, a read-only operating mode (e.g. wherein data is presented in an non-editable format), a user-defined operating mode (e.g. a operating mode with user-saved preferences), or a user-specific operating mode (e.g. a operating mode specific to a particular user such as the particular user's email account presented by an email client application). The operating mode in which the application opens in may dictate the behaviour of the application when the application has just been opened. It will be appreciated that the user may, or may not, be able to change the operating mode of the device after the application has been opened.

An application may comprise computer software designed to help the user to perform one or more related specific tasks. An application may comprise a combination of one or more of, for example, enterprise software, accounting software, an office suite, a word processor, a spreadsheet, a web browser, an email client, graphics software, a social media application, and a media player.

An application icon may be a graphical and/or textual icon displayed on a graphical user interface (GUI).

A first said operating mode may be a foreground operating mode and a second said operating mode may be a background operating mode.

A said user interaction may comprise a combination of one or more of:
a gesture interaction;
a multi-touch gesture;
a tap gesture;
a drag gesture;
a scroll input;
a key press; and
a button press.

A user interaction associated with an application icon may comprise a combination of one or more of:
a user interaction with the user interface at the same time as the application icon is selected or highlighted (e.g. highlighting the application icon and entering a series of one or more keystrokes); and
a user interaction associated with the position of the application icon (e.g. clicking on an icon with an appropriately positioned scriber or cursor).

A (particular) user interaction and respective operating mode may be common to a plurality of application icons. For example, a click user interaction may open a web browser application in a foreground operating mode when associated with a web browser application icon, and open an email client application in a foreground operating mode when associated with an email client application icon.

A user interaction and respective operating mode may be different for a plurality of application icons. For example, a swipe user interaction may open a web browser application in a safe background operating mode when associated with a web browser application icon, and open an email client application in a foreground operating mode when associated with an email client application icon.

The apparatus (memory and/or processor) may be configured to recognize a said user interaction as being entered by a particular user (e.g. scribing a signature over the icon). In response to a particular user interaction, the apparatus may enable the associated application to be opened in a user-specific operating mode (e.g. open the email account of the particular user).

A said user interaction may provide:
authentication information, the authentication information configured to enable the device to authenticate a particular user.

In this way the functions of authentication and opening the application may be performed in a single user interaction. This may reduce the number of steps required to open an application such that it can be used by the user.

The apparatus (memory and/or processor) may be configured to:
in response to detecting a plurality of user interactions, enable a plurality of instances of the application to be opened, each instance corresponding to a said detected user interaction.

The apparatus (memory and/or processor) may be configured to:
request user input (authentication data, password) before completing opening the application in the respective operating mode.

Opening an application may comprise initializing and/or executing an application such that it can be used by the user. Opening an application may comprise moving data relating to the application to active memory such that the data can be operated upon.

The application may be an email client, a word processer, a mobile phone application, a calendar, a spreadsheet, a media player, an mp3 player, a web browser, a social media application, or a game.

The user interface may comprise a combination of one or more of a wand, a pointing stick, a touchpad, a touch-screen, a mouse, a keyboard, a joystick, a remote controller, a button, a motion detector, a position detector, a scriber and an accelerometer.

The apparatus (memory/processor) may be configured to detect a particular user interaction from a plurality of detectable user interactions associated with a particular application icon on a user interface of an electronic device.

The electronic device may be a portable electronic device, a laptop computer, a tablet computer, a desktop computer, a mobile phone, a Smartphone, a monitor, a personal digital assistant or a digital camera. The apparatus may be a module for an electronic device or portable electronic device.

In a second aspect there is provided a method, the method comprising:
detecting a particular user interaction, from a plurality of detectable user interactions, each of the plurality of detectable user interactions associated with
   a particular application icon on a user interface of an electronic device, and
   one of a plurality of operating modes of the application associated with the particular application icon; and
initiating automatic opening of the particular application in the respective one of the plurality of operating modes associated with the detected particular user interaction.

In a third aspect there is provided a computer program, the computer program comprising computer code configured to:
detect a particular user interaction, from a plurality of detectable user interactions, each of the plurality of detectable user interactions associated with
   a particular application icon on a user interface of an electronic device, and
   one of a plurality of operating modes of the application associated with the particular application icon; and

initiate automatic opening of the particular application in the respective one of the plurality of operating modes associated with the detected particular user interaction.

The computer program may be stored on a storage media (e.g. on a CD, a DVD, a memory stick or other non-transitory media). The computer program may be configured to run on a device or apparatus as an application. An application may be run by a device or apparatus via an operating system.

In a fourth aspect there is provided an apparatus, the apparatus comprising:
means of detecting configured to detect a particular user interaction, from a plurality of detectable user interactions, each of the plurality of detectable user interactions associated with
   a particular application icon on a user interface of an electronic device, and
   one of a plurality of operating modes of the application associated with the particular application icon; and
means of initiating configured to initiate automatic opening of the particular application in the respective one of the plurality of operating modes associated with a detected particular user interaction.

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying drawings, in which:

FIG. 1 depicts an embodiment comprising a number of electronic components, including memory, a processor and a communication unit.

FIG. 2 illustrates an embodiment comprising a touch-screen.

FIG. 3a-3d depicts the embodiment of FIG. 2 as the user is opening a number of applications in different operating modes.

FIG. 4a-4d depicts a further embodiment as the different users are opening the same application in different user-specific, user-defined operating modes.

FIG. 5 depicts a flow diagram describing the method used to open applications in respective operating modes according to the user interaction detected.

FIG. 6 illustrates schematically a computer readable media providing a program according to an embodiment of the present invention.

### DESCRIPTION OF EXAMPLE ASPECTS/EMBODIMENTS

For the sake of convenience, different embodiments depicted in the figures have been provided with reference numerals that correspond to similar features of earlier described embodiments. For example, feature number 1 can also correspond to numbers 101, 201, 301 etc. These numbered features may not have been directly referred to within the description of these particular embodiments. These have still been provided in the figures to aid understanding of the further embodiments, particularly in relation to the features of similar described embodiments.

It is common for a user to employ an electronic device to allow a plurality of applications to be opened and run (e.g. simultaneously). Generally, the user is provided with an icon, a menu or a command line interface with which to initiate the running of an application.

Generally, when an application is opened, it is opened in the foreground. That is, it appears in front (or ‘on top’) of whatever else was displayed on the screen at the time and focus is directed to the newly launched application. So, for example, if a user is using a text editor on a laptop and then launches, or opens, a web browser, when the web browser opens it will be displayed in front of text editor because it has been automatically launched in a foreground operating mode. Normally this may not be a problem as programs are generally opened when they are needed.

Nevertheless, many devices also allow applications to be run in a background operating mode. Generally, to configure an application to run in a background operating mode, the user first opens the application and then once the application is open, configures it to be in a background operating mode (e.g. by minimising the application ‘window’, or opening a further application which opens in the foreground operating mode). It may be advantageous to allow the user to open an application directly into one of a plurality of operating modes.

Example embodiments contained herein may be considered to provide a way of initiating automatic opening of a particular application in a respective operating mode associated with a detected particular user interaction in response to detecting the particular user interaction from a plurality of detectable user interactions, each of the plurality of detectable user interactions associated with a particular application icon on a user interface of an electronic device, and one of a plurality of operating modes of the application associated with the particular application icon. This may reduce the number of interactions required to open a particular application in a particular operating mode.

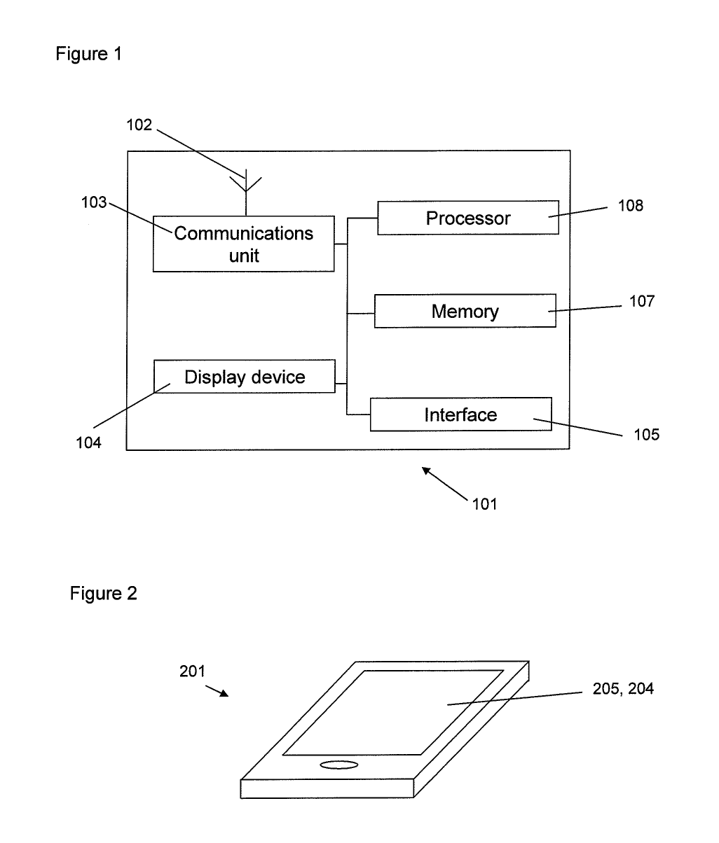

FIG. 1 depicts an apparatus (101) of an embodiment, such as a mobile phone. In other embodiments, the apparatus (101) may comprise a module for a mobile phone (or PDA or audio/video player), and may just comprise a suitably configured memory (107) and processor (108).

The embodiment of FIG. 1, in this case, comprises a display device (104) such as, for example, a Liquid Crystal Display (LCD) or touch-screen user interface. The apparatus (101) of FIG. 1 is configured such that it may receive, include, and/or otherwise access data. For example, this embodiment (101) comprises a communications unit (103), such as a receiver, transmitter, and/or transceiver, in communication with an antenna (102) for connecting to a wireless network and/or a port (not shown) for accepting a physical connection to a network, such that data may be received via one or more types of networks. This embodiment comprises a memory (107) that stores data, possibly after being received via antenna (102) or port or after being generated at the user interface (105). The processor (108) may receive data from the user interface (105), from the memory (107), or from the communication unit (103). It will be appreciated that, in certain embodiments, the display device (104) may incorporate the user interface (105). Regardless of the origin of the data, these data may be outputted to a user of apparatus (101) via the display device (104), and/or any other output devices provided with apparatus. The processor (108) may also store the data for later user in the memory (107). The memory (107) may store computer program code and/or applications which may be used to instruct/enable the processor (108) to perform functions (e.g. read, write, delete, edit or process data).

FIG. 2 depicts an embodiment of the apparatus comprising a portable electronic device (201), e.g. such as a mobile phone or tablet computer, with a user interface comprising a touch-screen user interface (205, 204), a memory (not shown), a processor (not shown) and an antenna (202) for transmitting and/or receiving data (e.g. emails, textual messages, phone calls, information corresponding to web pages).

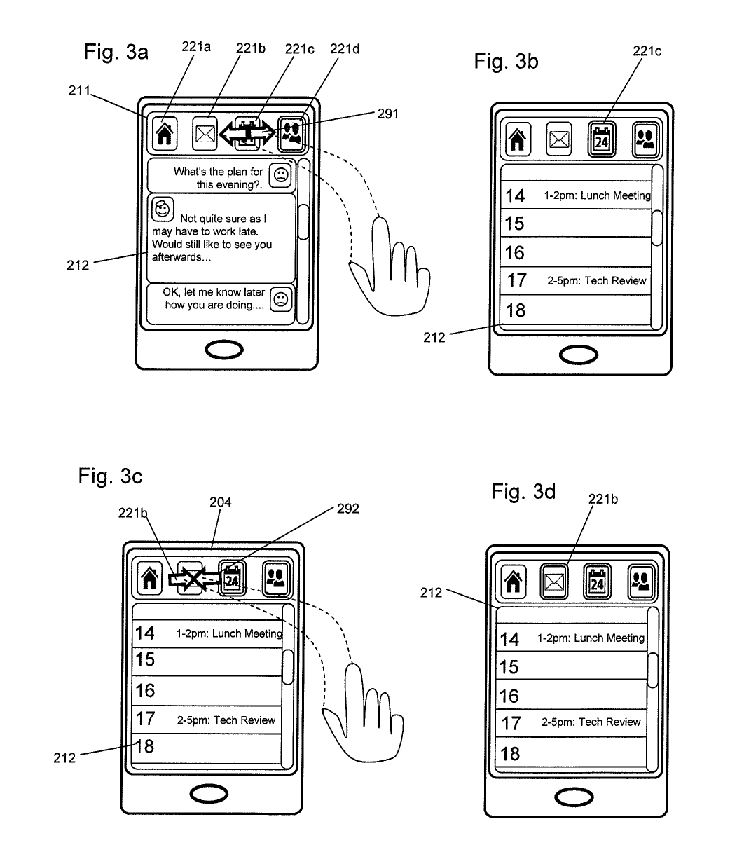

FIG. 3a-d illustrates a series of views of the embodiment of FIG. 2 when the device (201) is in use. In this example, the user wants to open the calendar application in a foreground operating mode and then an email client application in a background operating mode. In this case, the plurality of user interactions associated with each application icon is the same. That is, a first particular interaction with any of the plurality of application icons will open the corresponding application in a corresponding first operating mode.

To facilitate the opening of applications, this embodiment has an application interaction mode wherein the touch-screen user interface (205) is divided into two regions: an application icon region (211) comprising a number of application icons (221a-22d); and an application region (212) which is configured to display one or more running applications. The application icons corresponding to non-running applications are denoted by a single line border around the application icon. The application icons corresponding to running applications are denoted by a double line border around the application icon.

In the situation depicted in FIG. 3a, the user has already opened a messaging application which is running in a foreground operating mode in the application region (212). The messaging application icon (221d) is denoted as corresponding to a running application by a double line border. In this situation, the user also wants to open a calendar application, for example, to check what he is doing in the upcoming week. He therefore wants rapid access to the calendar application so he wishes to open the calendar application in a foreground operating mode. A foreground operating mode, for this embodiment, is one in which an application is placed ‘on top’ in the application region (212) such that it is immediately visible and accessible to the user.

In this case each of the applications can be opened in a foreground operating mode by interacting with the corresponding application icon using a spreading user interaction (291). The user therefore uses a spreading user interaction to interact with the calendar application icon, as depicted in FIG. 3a. A spreading user interaction (291) is where the user places his finger and thumb (for example) on the screen in contact with the application icon and then slides his finger and thumb away from each other (e.g. before removing his finger and thumb from the screen). For this embodiment a spreading interaction is associated with each of the plurality of icons (221a-221d) as being indicative of a foreground operating mode.

In response to detecting the spreading user interaction (291), from a plurality of detectable user interactions associated with the calendar application icon on a user interface of an electronic device, the apparatus (201) is configured to initiate automatic opening of the particular calendar application in a foreground operating mode associated with the detected spreading user interaction (291). This is depicted in FIG. 3b. The calendar application icon (221c) is distinguished as corresponding to a running application by having a double line border. When running in a foreground operating mode, in this embodiment, the calendar application occupies the entire application region (212). The messaging application, which was previously running in a foreground operating mode, now runs in a background operating mode by default.

The user now wishes to open his email client. However, in this case, the email client takes some time to receive new messages from the server and the user may find it tedious to wait until the email client is ready to be used. In this case, he wishes to open the email client in a background operating mode. This may allow him to continue to interact, uninterrupted, with the calendar application running in a foreground operating mode, until he is sure that the email client has received all of the data from the server and is ready to be used by the user.

In this case each of the applications can be opened in a background operating mode by interacting with the corresponding application icon using a pinching user interaction (292). A pinching user interaction (292) is where a user places his finger and thumb (for example) on the touch-screen user interface (204) in contact with the application icon and then slides his finger and thumb towards each other (e.g. before removing his finger and thumb from the screen). This is depicted in FIG. 3c.

In response to detecting a pinching user interaction (292), from a plurality of detectable user interactions associated with the email client application (221b) icon on a user interface of an electronic device, the apparatus initiates automatic opening of the email client application in a background operating mode associated with the detected pinching user interaction (292).

This is depicted in FIG. 3d. The email client application icon (221b) is distinguished as corresponding to a running application by having a double line border. When running in a background operating mode, in this embodiment, the email client application is not visible in the application region (212). The calendar application, which was previously running in a foreground operating mode, remains running in a foreground operating mode.

It will be appreciated that, for this example, the operating mode of the application may be changed by the user after the application has been opened. For example, in the situation depicted in FIG. 3d, the user may change the operating mode of the open calendar application and open the email client application into the foreground by clicking on the email client application icon. This would change the operating mode of the email client application from being in a background operating mode into being in a foreground operating mode, and the operating mode of the calendar application from being in a foreground operating mode into being in a background operating mode. For other embodiments, operating modes, applications and/or user interactions the operating mode of the application may or may not be changeable after the application has been opened.

Other examples where a user may wish for an application to be opened in a background operating mode may include when an application takes a long time to launch, or to initialise once launched (e.g. navigation software that will take time to obtain a GPS fix, opening a file comprising large amounts of data). By launching such applications in the background the user may continue to perform other tasks whilst waiting for the application to become ready. Another situation where a user may wish for an application to be opened in a background operating mode may be when a user wishes to run a particular application which does not require active input from the user. For example, a user may want to listen to Internet radio whilst writing an e-mail, in which case, he may only require that the radio client application is running and is not interested in interacting with it, so may launch it in the background (e.g. before launching the e-mail client application). It will be appreciated that the radio application may provide for audio content to the user (and maybe even allow the varying of volume or channel selection (e.g. channel up/down), which may be done using a control buttons on a headset accessory) whilst it is in the background mode, but that the application will need to be in the foreground mode to allow a user to fully interact with the application user interface e.g. to see detailed aspects of the application user interface which allow the functionality provided by the application to be fully controlled.

Designating the operating mode in which an application is to be opened, by interacting with the application icon using a particular predetermined interaction, may make the opening procedure more efficient. That is, the interaction (e.g. a single interaction) denotes that the user wishes the application to be opened and also in which operating mode the application is to be opened. That is, the number of user interactions to open the application in a particular operating mode may not be increased compared to the number of interactions required to open the application in a default operating mode. Indeed, the number of user interactions to open the application in a particular operating mode may be reduced compared to the number of interactions required to open the application in a default operating mode and then configure the open application to run in a particular operating mode. For example, the user may not need to type additional command line parameters, or open and navigate a special menu. Instead, it is the user interaction (e.g. gesture) that he uses to open the application that denotes the operating mode in which the application will be opened.

It will be appreciated that a said user interaction may be any touch gesture (e.g. single or multiple clicks, swipe, rotate, multi-touch gestures). For example, the user could use a tap gesture to open the corresponding application in a foreground operating mode, and a drag gesture to open the corresponding application in a background operating mode. It will be appreciated that a said user interaction may be any particular user interaction (including with hardware keys) with the application icon. For example, a user interaction may comprise pressing one or one of two different hardware keys whilst the icon is selected.

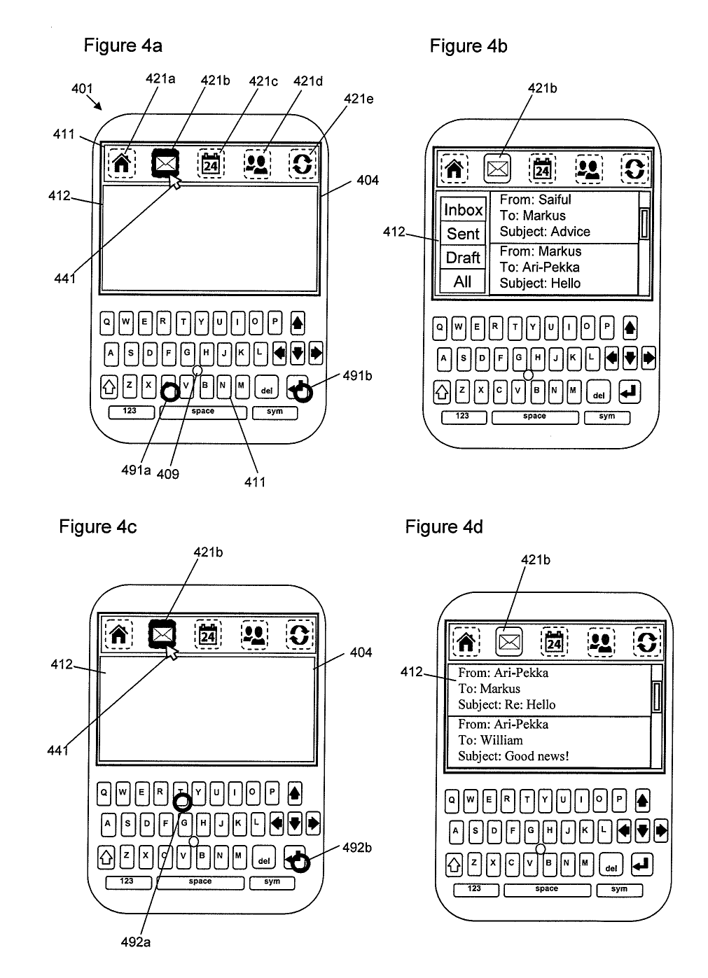

FIG. 4a illustrates a further embodiment (401) of an apparatus such as a personal digital assistant device comprising a user interface, the user interface comprising a pointing stick (409), a key user interface (411) which, in this case, is a physical keyboard. This embodiment further comprises a screen (404); a processor and memory (not shown). Unlike the apparatus of FIG. 2 in which the user interface and the display functions were both provided by a touch-screen, in this embodiment these functions are provided by a screen (404), a physical keyboard (411) and a pointing stick (409).

Like the previous embodiment, to facilitate the opening of applications, this embodiment has an application interaction mode wherein the touch-screen user interface (205) is divided into two regions: an application icon region (411) comprising a number of application icons (421a-421e); and an application region (412) which is configured to display running applications. In this embodiment (401), the application icons (421a-421e) corresponding to non-running applications are denoted by a dotted line border around the application icon. The application icons corresponding to running applications are denoted by a solid line border around the application icon. It will be appreciated that, for other example, embodiments the application icons may, or may not, denote whether the applications are running or not. It will be appreciated that, for other example, embodiments the application icons may, or may not, denote in which operating mode the applications are running.

In this case the applications include an email client application associated with an email client application icon (421b). In this case, the email client application of the device is configured to be used by a plurality of users, where each of the plurality of users have a corresponding email address and associated messages. In this example, the email client can be opened in a first user operating mode or a second user operating mode depending on the respective user interaction used to open the email client application.

FIG. 4a depicts the device when none of the applications have been opened. In this case, there is no running application and so the application region (411) of the screen (404) is empty. As none of the applications have been opened all of the application icons are denoted as corresponding to non-running applications by a dotted line around the application icon.

In this case the first user wishes to open his email account and check whether he has received any new emails. The first user therefore interacts with the application using a first user interaction in order to open the email client application in a corresponding first user operating mode. In this case, the first user interaction comprises navigating, for example using the pointing stick (409), a cursor (441) to be positioned over the email client application icon (421c) so as to provisionally select the icon. The application icon, in this case, is denoted as being provisionally selected by the background of the icon changing colour (to black). The first user interaction in this case further comprises pressing the enter key (491b) and the ‘C’ letter key (491a).

In response to detecting the particular first user interaction from a plurality of detectable user interactions, each of the plurality of detectable user interactions associated with a particular application icon on a user interface of an electronic device, and one of a plurality of operating modes of the application associated with the particular application icon, the apparatus is configured to initiate automatic opening of the particular email client application in a respective first user operating mode associated with the detected particular user interaction.

In this case (depicted in FIG. 4b) the first user operating mode of the email client application defines which emails are shown (e.g. in this case, emails associated with the first user), and user defined preferences. That is the first user operating mode is a user-specific operating mode (as it relates to information provided for the first user) and a user-defined operating mode (as the user has defined preferences as to how the information is presented). For example, in this case, the layout of the viewing pane and the fonts (e.g. Arial) used have been predefined by or set for the first user and are loaded when the email client application is loaded in a first user operating mode.

FIG. 4c depicts the device, in an analogous situation to that of FIG. 4a, when none of the applications have been opened. In this case, there is no running application and so the application region (412) of the screen (404) is empty. As none of the applications have been opened all of the application icons are denoted as corresponding to non-running applications by a dotted line around the application icon.

In this case the second user wishes to open her email account, for example, in order to compose and send a new email. The second user therefore interacts with the email client application icon (421b) using a second user interaction in order to open the email client application in a corresponding second user operating mode. In this case, the first user interaction comprises navigating a cursor (441) to be positioned over the email client application icon (421b) so as to provisionally select the icon. The email client application icon (421b), in this case, is denoted as being provisionally selected by the background of the icon changing colour (to black). The first user interaction in this case further comprises pressing the enter key (492b) and the ‘T’ letter key (492a) (i.e. the second user interaction is distinguished by pressing the ‘T’ letter key rather than the ‘C’ letter key).

In response to detecting a particular second user interaction, from a plurality of detectable user interactions associated with a particular application icon on a user interface of an electronic device, the apparatus is configured to initiate automatic opening of the particular email client application in a respective second user operating mode associated with the detected particular user interaction.

In this case the second user operating mode of the email client application defines which emails are shown (e.g. emails associated with the second user), and user defined preferences. For example, in this case (depicted in FIG. 4d), the layout of the viewing pane and the fonts (e.g. Times New Roman) used have been predefined by or set for the second user and are loaded when the email client application is loaded in a second user operating mode (e.g. in response to detecting a second user interaction). That is, the information provided to the user, and the manner in which it is provided, is distinct in FIG. 4b and FIG. 4d due to the respective operating mode, even though it is the same application running in the application region (412).

It will be appreciated that, for this example, the operating mode of the application may not be changed by the user after the application has been opened. For example, in the situation depicted in FIG. 4d, the second user may be prevented from changing the o operating mode of the open email client application to a first user operating mode. In order to access the first operating mode of the application, the application may be closed and opened using a first user interaction in a first user operating mode, or another instance of the application may be opened.

It will be appreciated that for some applications other operating modes (and corresponding user interactions) may be available. For example, other example embodiments may enable an application to be opened in one or more of, for example, a background operating mode, a foreground operating mode, a safe operating mode, an edit operating mode, a sleep operating mode, a read-only operating mode, a user-defined operating mode, or a user-specific operating mode.

It will be appreciated that the device may be configured to initiate but not complete opening in a particular operating mode. For example, the apparatus may require further user input such as authentication (e.g. by entering a password) before the apparatus completes the opening of the application in the respective operating mode associated with the particular user interaction. It will be appreciated that, for other example embodiments, the authentication may form part of the user interaction with the application icon. For example, the user interaction may comprise typing a password whilst the application icon is provisionally selected, or scribing a signature over the application icon displayed on a touch screen.

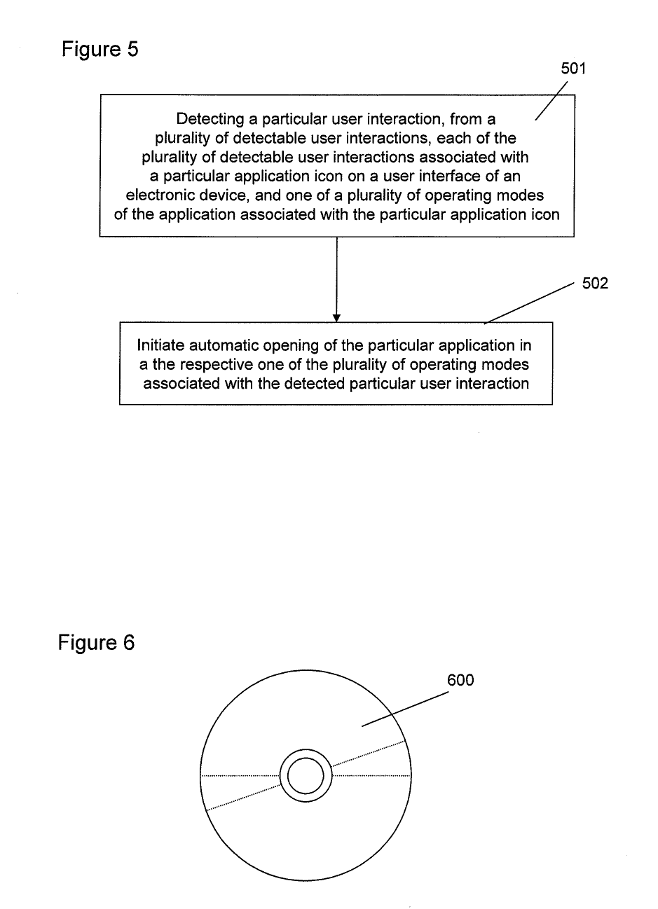

FIG. 5 shows a flow diagram illustrating the opening of an application in a particular operating mode in response to detecting a particular user interaction and is self-explanatory.

FIG. 6 illustrates schematically a computer/processor readable media 600 providing a program comprising computer code which implements one or more of the aforementioned embodiments. In this example, the computer/processor readable media is a disc such as a digital versatile disc (DVD) or a compact disc (CD). In other embodiments, the computer readable media may be any media that has been programmed in such a way as to carry out an inventive function.

It will be appreciated to the skilled reader that any mentioned apparatus/device and/or other features of particular mentioned apparatus/device may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

With reference to any discussion of any mentioned computer and/or processor and memory (e.g. including ROM, CD-ROM etc), these may comprise a computer processor,

Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
detect a particular user interaction from a plurality of detectable user interactions, each of the plurality of detectable user interactions associated with
a particular application icon on a user interface of an electronic device, and
one of a plurality of operating modes of the application associated with the particular application icon; and
initiate automatic opening of the particular application in the respective one of the plurality of operating modes associated with the detected particular user interaction.

2. The apparatus of claim 1, wherein a said operating mode is a background operating mode, a foreground operating mode, a safe operating mode, an edit operating mode, a sleep operating mode, a read-only operating mode, a user-defined operating mode, or a user-specific operating mode.

3. The apparatus of claim 1, wherein a first said operating mode is a foreground operating mode and a second said operating mode is a background operating mode.

4. The apparatus of claim 1, wherein a said user interaction comprises a combination of one or more of:
a gesture interaction;
a multi-touch gesture;
a tap gesture;
a drag gesture;
a scroll input;
a key press; and
a button press.

5. The apparatus of claim 1, wherein a said user interaction associated with an application icon comprises a combination of one or more of:
a user interaction with the user interface at the same time as the application icon is selected or highlighted; and
a user interaction associated with the position of the application icon.

6. The apparatus of claim 1, wherein a said user interaction provides:
authentication information, the authentication information configured to enable the device to authenticate a particular user.

7. The apparatus of claim 1, wherein the at least one processor and memory are configured to:
in response to detecting a plurality of user interactions, enable a plurality of instances of the application to be opened, each instance corresponding to a said detected user interaction.

8. The apparatus of claim 1, wherein the at least one processor and memory are configured to:
request user input before completing opening the application in the respective operating mode.

9. The apparatus of claim 1, wherein the at least one processor and memory are configured to detect a particular user interaction from a plurality of detectable user interactions associated with a particular application icon on a user interface of an electronic device

10. The apparatus of claim 1, wherein the application is an email client, a word processer, an mobile phone application, a calendar, a spreadsheet, a media player, an mp3 player, a web browser or a game.

11. The apparatus of claim 1, wherein the user interface comprises a combination of one or more of a wand, a pointing stick, a touchpad, a touch-screen, a mouse, a keyboard, a joystick, a remote controller, a button, a motion detector, a position detector, a scriber and an accelerometer.

12. The apparatus of claim 1, wherein the electronic device is a portable electronic device, a laptop computer, a desktop computer, a mobile phone, a Smartphone, a monitor, a personal digital assistant or a digital camera.

13. The apparatus of claim 1, wherein the apparatus is a module for an electronic device.

14. A method, the method comprising:
detect a particular user interaction, from a plurality of detectable user interactions, each of the plurality of detectable user interactions associated with
a particular application icon on a user interface of an electronic device, and
one of a plurality of operating modes of the application associated with the particular application icon; and
initiating automatic opening of the particular application in the respective one of the plurality of operating modes associated with the detected particular user interaction.

15. A computer program, the computer program comprising computer code configured to:
detecting a particular user interaction, from a plurality of detectable user interactions, each of the plurality of detectable user interactions associated with
a particular application icon on a user interface of an electronic device, and
one of a plurality of operating modes of the application associated with the particular application icon; and
initiate automatic opening of the particular application in the respective one of the plurality of operating modes associated with the detected particular user interaction.
